(19) United States
(12) Patent Application Publication
(10) Pub. No.: US 2025/0313102 A1
(43) Pub. Date: Oct. 9, 2025

(54) WIRELESS POWER TRANSFER SYSTEM

(71) Applicant: ELSSWAY LTD., Tel Aviv (IL)

(72) Inventor: Asaf Manova ELSSIBONY, Tel Aviv (IL)

(73) Assignee: ELSSWAY LTD., Tel Aviv (IL)

(21) Appl. No.: 18/866,773

(22) PCT Filed: May 17, 2023
(86) PCT No.: PCT/IL2023/050504

§ 371 Date: Nov. 18, 2024

Related U.S. Application Data
(60) Provisional application No. 63/342,680, filed on May 17, 2022.
(60) Provisional application No. 63/342,715, filed on May 17, 2022.
(60) Provisional application No. 63/342,754, filed on May 17, 2022.

(51) Int. Cl. B60L 53/122; B60L 53/126; H02J 50/12; H02J 50/90

(52) U.S. Cl. CPC B60L 53/122; B60L 53/126; H02J 50/12; H02J 50/90

(57) ABSTRACT

The present invention provides a novel wireless power transfer (WPT) system configured to cover relatively large area and volume while maintaining continuance, constant, high coupling and efficient energy transfer between the transmitter and the receiver of an in-motion wireless powering and charging system.

### FIELD OF THE INVENTION

The present invention is in the field of antennas for electromagnetic or electric field coupling between a transmitting unit and a receiving unit in wireless powering systems.

### BACKGROUND

Wireless charging techniques and systems for different type of energy sources are well known in the art, techniques and systems such as magnetic induction, magnetic resonance, capacitive coupling, RF power transfer, ultrasound and light, all the techniques and systems mentioned above required proximity and alignment between the transmitter and the receiver in order to maintain efficient power transfer within a well-known, limited, defined and restricted area or volume. Although the techniques and systems above may be use for wireless charging and powering a stationary device, these techniques and systems are not suitable for powering or charging in motion of mobile platform such as vehicles configured to be operated in either land, sea, air or space and characterized by their ability to be in motion or provide any form of transportation. Moreover, said solutions provide punctured and un-continuous charging by using multiple charging pads, wherein, due to physical constrains, are limited to emitting electrical or magnetic fields only within the borders of the dimensions of said charging pads, hence strict and full alignment is required.

Accordingly, there is a need for a wireless powering and charging system that can cover large area and volume while maintaining high, strong and stable coupling and high efficiency power transfer between the transmitter and the at least one receiver.

### SUMMARY OF INVENTION

The present invention provides a novel wireless power transfer (WPT) system configured to cover relatively large area and volume while maintaining continuance, constant, high coupling and efficient energy transfer between the transmitter and the receiver of an in-motion wireless powering and charging system.

In contrast to the aforementioned prior art, in which both the transmitting and the receiving antennas or coils are designed to have self-resonance in the same frequency, with or without the presence of the complementary (second) antenna or coil, in order to achieve high energy transfer efficiency, the disclosed spatial WPT system for wireless power transfer predefine resonance frequency is designable, determined and occurring by both transmitting antenna and receiving antenna.

The present invention provides a novel near field spatial WPT and conductors system and method configured to cover relatively large area and volume while maintaining high electromagnetic (EM) coupling and high power transfer efficiency between the transmitter/s and the receiver/s as part of a mobile wireless powering and charging system.

The system comprises a constant and continuous EM coupling between a signal conductor, a ground conductor (both connected to the same alternating power source) and a receiving antenna allowing a mobile platform to receive a substantially constant stream of power without intervals of resonance and coupling along and across the path of an arrangement of said conductors.

An additional advantage of the invention is that the relation between the receiving antenna and the transmitter conductors enable such uninterrupted substantially constant stream of power without intervals of resonance and coupling wirelessly powering or charging the mobile platform (wherein said mobile platform may be any type of locomotor/vehicle, either autonomous or controllable, and configured to be operatable above or under the ground, above or under water, in air, space, etc.). Said arrangement is also configurable to be flexible whereby the mobile platform's position and proximity in relation to the transmitting conductors does not require strict alignment or overlapping with WPT system components.

An additional advantage of the invention is that more than one mobile platform can be powered by same WPT system using same transmitting antenna and conductors' assembly, at the same time without substantially reducing the performance of the system.

In contrast to the prior art, in which both the transmitting and the receiving antennas or coils are designed to have self-resonance in the same frequency to achieve high energy transfer efficiency, the spatial resonance system for wireless power transfer, hereby introduced, determines the resonance frequency which is determined and occurs by both transmitting antennas (continuous conductors) and receiving antenna (receiving conductors).

According to one aspect, there is provided a near field power system, comprising: at least one alternating power signal source, at least one signal conductor configured to receive an electrical signal from said power signal source and further configured to be stretched along a path, at least one ground conductor configured to be in communication with a ground of said power signal source and further configured to be stretched along said path, and at least one receiving antenna connected to receiving unit configured to be mounted on at least one mobile platform, wherein the signal conductor is configured to be disposed in a predefined distance from the ground conductor whereby a designated charging volume is formed and a resonance occurs within said charging volume.

According to some embodiment, the WPT system, contains the transmitting antenna and receiving antenna, maintaining high coupling and energy transfer efficiency within the relatively large area and volume covered, regardless of the position, location, rotation, orientation, alignment, overlapping etc. of the receiving antenna relatively to the transmitting antenna.

According to some embodiments, the resonance within charging volume designates a constant and continuous EM coupling between the said signal and ground conductors and the receiving antenna.

According to some embodiments, the at least one alternating power signal source is a transmitter configured to generate such signal.

According to some embodiments, the at least one alternating power signal source is in communication with the receiving antenna whereby the function of the other conductors is modified accordingly.

According to some embodiments, the designated distance separating the signal and ground conductors along the path determines the dimensions of the charging volume.

According to some embodiments, the at least one mobile platform is configured to be charged through the receiving antenna connected to receiving unit by the constant EM coupling creating a wireless charging volume.

According to some embodiments, the at least one mobile platform is stationary within the charging volume.

According to some embodiments, the at least one signal conductor is configured to be placed between at least two ground conductors, and wherein said conductors are configured to be spaced by a designated distance along the path.

According to some embodiments, the at least one signal conductor and the at least one ground conductor are configured to be mounted on ground level.

According to some embodiments, the at least one signal conductor and the at least one ground conductor are configured to be mounted beneath ground level.

According to some embodiments, the at least one signal conductor and the at least one ground conductor are configured to be mounted on a vertical surface.

According to some embodiments, wherein the at least one signal conductor and the at least one ground conductor are configured to be mounted on a moving object.

According to some embodiments, the at least one signal conductor and the at least one ground conductor are configured to be made of a conductive material having a thickness of 50-150 micron.

According to some embodiments, the at least one signal conductor and/or the at least one ground conductor are of an elongated sheet shape.

According to some embodiments, the at least one signal conductor and/or the at least one ground conductor have circular cross-sections.

According to some embodiments, the receiving antenna connected to receiving unit is mounted on a mobile platform and wherein the receiving antenna is configured to maintain a continuous EM coupling with the at least one signal conductor and the at least one ground conductor during operation or movement along or across the path.

According to some embodiments, the receiving antenna is mounted on a mobile platform and maintains a constant and continuous EM coupling with the at least one signal conductor and the at least one ground conductor while moving near the path but not necessarily in alignment with the path.

According to some embodiments, the receiving antenna is configured to maintain constant and continuous EM coupling with the at least one signal conductor and the at least one ground conductor if it remains within a charging volume.

According to some embodiments, the operational constant and continuous EM coupling is maintained with the at least one signal conductor and the at least one ground conductor by a height control means.

According to some embodiments, the at least one receiving antenna may be mounted on any section of the mobile platform.

According to some embodiments, the mobile platform is an autonomous vehicle configured to move along or across the path.

According to some embodiments, the autonomous vehicle is a logistic vehicle configured to move within an operational environment.

According to some embodiments, the mobile platform is an electrical vehicle (EV) configured to keep full operability while charging.

According to some embodiments, the at least one signal conductor, or the at least one ground conductor are configured to have different dimensions along their length to provide adaptive resonance and EM coupling capabilities.

According to some embodiments, the different dimensions are at least one non-parallel section forming a part of the at least one signal conductor and/or the at least one ground conductor.

According to some embodiments, multiple sections of signal conductors and ground conductors are placed in a consecutive manner along the path.

According to some embodiments, multiple sections of signal conductors and ground conductors are placed in a consecutive manner widthwise the path.

According to one embodiment of the invention, WPT system will only resonate at the predefined frequency when the receiving antenna is present within the predefined charging volume. In order to achieve such resonance condition, the receiving antenna and transmitting antenna need to have mutual electromagnetic influence which leads to such resonance.

According to some embodiment of the invention, the novel WPT system receiving antenna and transmitting antenna maintain a similar resonance condition if the receiving antenna is present within the charging volume and without any limitation or requirement of position, orientation, rotation, alignment, overlapping, placement, etc. with regards to the transmitting antenna. In other words, and according to some embodiments of the invention, the novel WPT system maintains a spatial resonance condition, at the predefined frequency, between the transmitting antenna and the at least one receiving antenna for any placement, location, orientation, rotation, alignment, overlapping etc. while the receiving antenna is located within the predefined charging volume.

According to some embodiment of the invention, the resonance condition of novel WPT system reflected a high coupling coefficient and efficient wireless power transfer between the transmitting antenna and the receiving antenna for any placement, location, orientation, rotation, overlapping, alignment, etc. while the receiving antenna is located within the predefined charging volume.

According to some embodiments, the EM resonance is creatable only when a mobile platform having a receiving antenna is present within a designated charging volume.

According to some embodiments, multiple EM resonances are created for each of at least two mobile platforms having a receiving antenna and move along the path.

According to some embodiment, the transmitting antenna can be coupled to one or more receiving antennas of the WPT system, and powering multi wireless consumers. In such scenario, and according to some embodiments, multiple EM resonance are created for each of at least two receiving antenna locates within the designated charging volume of the WPT system, meaning that the transmitting antenna is electromagnetically coupled with the at least two receiving antennas, and power is wirelessly transferred from the transmitting antenna to the at least two receiving antennas, where the WPT system functions as a wireless power divider.

According to a second aspect, there is provided a method for using a near field power system, comprising the steps of: providing an alternating power signal produced by at least one transmitter, communicating said alternating power signal to at least one signal conductor while the at least one ground conductor is in communication with the transmitter ground, wherein both conductors are configured to be stretched along a path and disposed in predefined distance from each other, providing wireless power to at least one receiving antenna connected to at least one receiving unit (rectifier) configured to be mounted on and powering or charging at least one mobile platform, forming an electromagnetic (EM) resonance between the at least one signal conductor together with at least one ground conductor and the receiving antenna and creating a constant and continuous EM coupling between the signal together with the ground conductors and the receiving antenna.

### BRIEF DESCRIPTION OF THE DRAWINGS

Examples illustrative of embodiments of the disclosure are described below with reference to figures attached hereto. In the figures, identical structures, elements, or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (Figs.) are listed below.

FIG. 1 illustrates a top view of at least one embodiment of WPT system transmitting antenna.

FIG. 2 illustrates at least one embodiment of the WPT system transmitting antenna dimension parameters.

FIG. 3A-3D illustrates a general back view of at least one embodiment of the WPT system transmitting antenna.

FIG. 4A-4B illustrate a top view of at least one embodiment of WPT system 200 with variety lengths of transmitting antenna 100.

FIG. 5A-5B illustrate a side view of at least one embodiment of WPT system 200 coupling and wireless power transfer with variety lengths of transmitting antenna 100.

FIG. 6 illustrates a top view of at least one embodiment of WPT system 200 with transmitting antenna 100 in the length of L2.

FIG. 7 illustrate a side view of at least one embodiment of WPT system 200 coupling and wireless power transfer with transmitting antenna 100 in the length of L2.

FIG. 8A-8B illustrates a top view of at least one embodiment of novel WPT system 300 coupling and wireless power transfer with transmitting antenna 2000 in the length of L2.

FIG. 9 illustrates a side view of at least one embodiment of the novel WPT system 300 coupling and wireless power transfer of transmitting antenna 2000 in the length of L2.

FIG. 10 illustrates a top view of at least one embodiment of WPT system transmitting antenna 100 with length L1.

FIG. 11A-11B illustrates a side view of at least one embodiment of the WPT system transmitting antenna 100 with length L1 field distribution and phase.

FIG. 12 illustrates a top view of at least one embodiment of WPT system transmitting antenna 100 with length L2.

FIG. 13A-13B illustrates a side view of at least one embodiment of the WPT system transmitting antenna 100 with length L2 field distribution and phase.

FIG. 14 illustrates a side view of at least one embodiment of novel WPT system described in FIG. 13A-13B.

FIG. 15A-15B illustrates a top view of at least one embodiment of novel WPT system transmitting antenna 3000.

FIG. 16A-16B illustrates a side view of at least one embodiment of the novel WPT system transmitting antenna 3000 with length L2 field distribution and phase.

FIG. 17A-17B illustrate a top view of at least one embodiment of novel WPT system 400.

FIG. 18 illustrates a side view of at least one embodiment of novel WPT system 400.

FIG. 19A-19B illustrate a bottom and side view of at least one embodiment of WPT system novel receiving antenna 210.

FIG. 20A-20F illustrate a side and bottom view of at least one embodiment of WPT system novel receiving antenna 210 parameters.

FIG. 21A-21G illustrate a side and bottom view of at least one embodiment of WPT system novel receiving antenna 210 variation.

FIG. 22A-22B illustrate a top view of at least one embodiment of WPT system 500 with variety lengths of transmitting antenna 100 with the same receiving antenna 210.

FIG. 23A-23B illustrate a side view of at least one embodiment of WPT system 500 coupling and wireless power transfer with variety lengths of transmitting antenna 100 with the same receiving antenna 210.

FIG. 24A-24B illustrate a side view of at least one embodiment of WPT system 500, presents simultaneous coupling and wireless power transfer with variety lengths of transmitting antenna 100 and receiving antennas 210 to 240.

It should be clear that the description of the embodiments and attached Figures set forth in this specification serves only for a better understanding of the invention, without limiting its scope. It should also be clear that a person skilled in the art, after reading the present specification could adjust or amend the attached figures and above-described embodiments that would still be covered by the present invention.

### DETAILED DESCRIPTION

The present invention provides a near field spatial WPT system to maintain high, continuance and constant coupling and energy transfer efficiency between the transmitter and the receiver of in motion or stationary wireless powering and charging system with coverage of relatively large area and volume, with regardless to the length of the transmitting antenna and the designated charging volume. The transmitting antenna length is proportional to the WPT system resonance frequency and wavelength. In order to maintain the same coupling condition for any and variety length of transmitting antennas, the same coupling coefficients and power transfer condition of the WPT system need to be maintained.

In other words, the WPT system needs to resonate at the same predefined frequency, by maintaining the same coupling and power transfer efficiency for any transmitting antenna length, with the same receiving antenna and with regardless to the quarter of the resonance frequency wavelength number or order.

Embodiments of the present invention provide a constant and continuously charging/powering WPT system for mobile platform while in motion or stationery positioned within a variety of predefine relatively large charging area or charging volume.

Where mobile platform may be any type of locomotor/vehicle, either autonomous or controllable, and configured to be operatable above or under the ground, above or under water, in air, space, etc.

Embodiments of the present invention provide power for one antenna cover area and volume greater than existing coils or antennas of other techniques.

Embodiments of the present invention provide power for devices with no batteries, or any other charging devices, or limiting battery usage in mobile or locomotor devices. In at least one embodiment, the novel near field spatial WPT system's transmitting antenna conductors may be meandering or partly meandering.

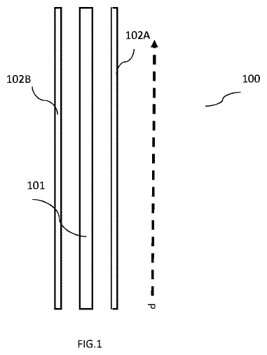

FIG. 1 illustrates a top view of the novel WPT system's transmitting antenna 100 signal conductor 101 and conductor ground 102A and ground conductor 102B.

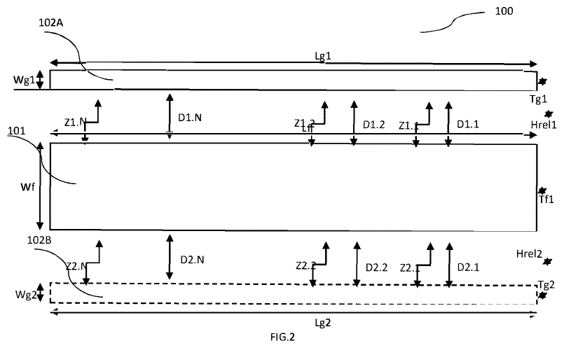

FIG. 2 illustrates at least one embodiment of the novel spatial WPT system transmitting antenna 100-dimension parameters. The dimension parameters of antenna conductor 101 and ground conductors 102A and 102B will determine the covered charging and powering area, the covered charging and powering volume, the field line distribution and so for a given frequency, and vice versa. The parameters are:
Wf—signal conductor 101 width
Lf—signal conductor 101 length
Tf—signal conductor 101 thickness
Wg1—ground conductor 102A width
Lg1—ground conductor 102A length
Tg1—ground conductor 102A thickness
Wg2—ground conductor 102B width
Lg2—ground conductor 102B length
Tg2—ground conductor 102B thickness
D1.1; D1.N—the distance between signal conductor 101 and ground conductor 102A
D2.1; D2.N—the distance between signal conductor 101 and ground conductor 102B
Hrel1.1; Hrel1.N—the relative height between signal conductor 101 and ground conductor 102A.
Hrel2.1; Hrel2.N—the relative height between signal conductor 101 and ground conductor 102B
Z1.1; Z1.N—the impedance between signal conductor 101 and ground conductor 102A.
Z1.1; Z1.N—the impedance between signal conductor 101 and ground conductor 102B.

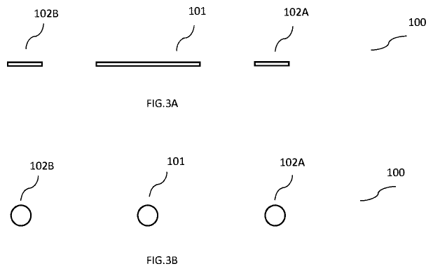

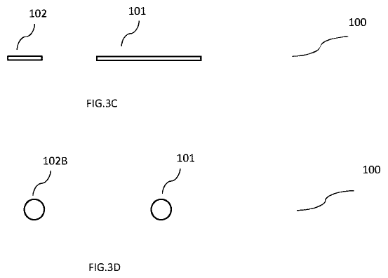

FIG. 3A-3D illustrates a back view of at least one embodiment of the novel spatial WPT system's transmitting antenna 100 having a flat signal conductor 101 and flat ground conductors 102A and 102B as shown in FIG. 2A, and wire signal conductor 101 and wire ground conductors 102A and 102B as shown in FIG. 2B. At least one embodiment novel spatial WPT system's transmitting antenna 100 will contain flat or wire signal conductor 101 and only one flat or wire ground conductor 102 as shown in FIG. 2C and FIG. 2D. In at least one embodiment the connectors of the novel spatial WPT system's transmitting antenna 100 is a combination of flat, wire, round or any other cross section shape.

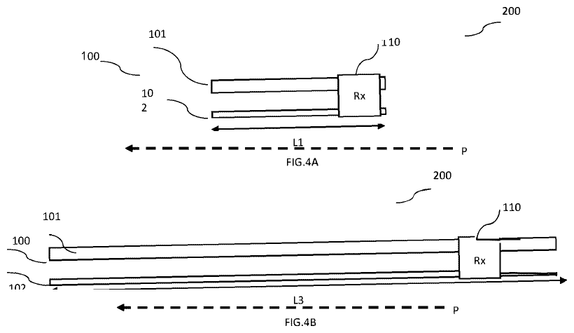

FIG. 4A-4B illustrates a top view of the novel WPT system's transmitting antenna 100 signal conductor 101 and conductor ground 102 and receiving antenna 110, where FIG. 4A presents transmitting antenna with length of L1 and FIG. 4B presents transmitting antenna 100 with of L3. The receiving antenna 110 of WPT system presents in both FIG. 4-9 is the same antenna.

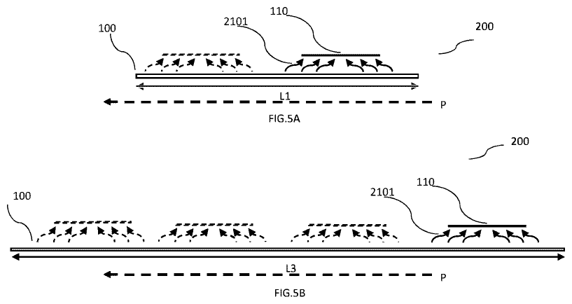

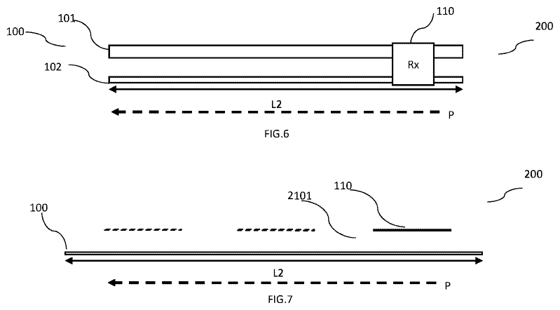

FIG. 5A-5B illustrates a side view of WPT system 200 resonates and power transfer at a predefined frequency. The resonance occurs only when receiving antenna 110 is present within the charging volume. As a result, a high coupling and highly efficient power transfer 2101 occurs between the transmitting antenna 100 and receiving antenna 110 of WPT system 200. In some embodiment of this invention, System 200 presents in FIG. 5A-5B resonates at the same frequency and held the same coupling coefficients and wireless power transfer efficiency for both transmitting antennas having a length of L1 and L3, when the same receiving antenna 110 is present within the predefined charging volume along and across direction P. In some embodiments of the present invention, WPT system will resonates at the same frequency and held the same coupling coefficients and wireless power transfer efficiency for any transmitting antenna with the length of Nλ/4m, where λ is the wavelength of the system 200 predefine resonance frequency and N=1,3 . . . is the number or odd order of quarters of wavelengths.

In other words, and according to some embodiments of the present innovation, the resonance condition, and the wireless power transfer efficiency between receiving antenna 110 and transmitting antennas with the same dimension parameters as describes in FIG. 2, with only differentiation in length parameter, remaining the same where the antenna's length L is approximately in order of Nλ/4, where N=1,3 . . . .

In some embodiments of the present invention, WPT system resonates at the same frequency and holds the same coupling coefficients and wireless power transfer efficiency for any transmitting antenna with the length of approximately Mλ/4, where λ is the wavelength of the wireless power transfer system predefine resonance frequency and M=2,4 . . . is the number or even order of quarters of wavelengths. In other words, and according to some embodiments of the present innovation, the resonance condition and the wireless power transfer efficiency between receiving antenna 110 and transmitting antennas with the same dimension parameters as describes in FIG. 2, with only differentiation in length parameter, remain the same where the antenna length L is approximately in order of Mλ/4, where M=2,4 . . . . For example, FIGS. 5A and 5B present transmitting antenna 100 length L1 is equal to 1λ/4 and L3 is equal to 3λ/4.

FIG. 6 illustrates a top view of the WPT system's transmitting antenna 100 signal conductor 101 and conductor ground 102 and receiving antenna 110, where receiving antenna 110 is the same as the antennas present in the previous figures. FIG. 6 present transmitting antenna with the same dimension parameters as describes in FIG. 4-5, with only differentiation in length parameter, where L2 is equal to 2λ/4.

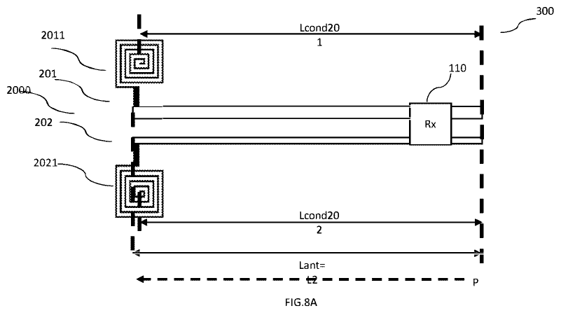

FIG. 7 illustrates a side view of WPT system 200 resonance and power transfer at a predefined frequency, where transmitting antenna 100 length is L2. As shown, and according to some embodiments of the present innovation, the WPT system presented in FIG. 4-5 does not resonate when the transmitting antenna 100 length is in a range of Mλ/4, where λ is the wavelength of the system 200 resonance frequency and M=2,4 . . . as the number and even order of quarters of wavelength λ/4. As a result, there is no condition for the creation of coupling and wireless power transfer between transmitting antenna 100 and receiving antenna 110.

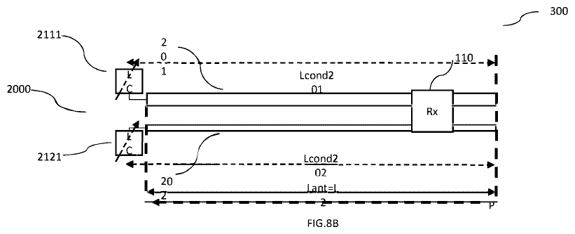

FIG. 8A-8B present some embodiment of the present invention and illustrates a top view of spatial WPT system's 300 transmitting antenna 2000 signal conductor 201 and conductor ground 202 and receiving antenna 110, where receiving antenna 110 is the same as the antenna present in the previous figures and the length of transmitting antenna is L2 as shown in the previous figures.

FIG. 8A present some embodiment of the present invention of a novel spatial WPT system with a transmitting antenna 2000. As shown, signal conductor 201 and ground conductor 202 designed in a way that from one hand keeps the required conductor length Lcond required for the WPT system to resonates in predefined frequency and form the other hand the transmitting antenna length Lant=L2 is shorter, where in this example Lcond=L3. As shown in FIG. 8A, and according to some embodiment of the present invention, the length of the signal conductor 201 and ground conductor 202 Lcond is equal to the transmitting antenna length Lant and the length of the conductor stub Lcs. Meaning that, Lcond201=Lant+Lcs2011 and Lcond202=Lant+Lcs2021. According to the present example, where Lant=L2 and Lcond=L3, Lcs=L3−L2. According to some embodiment of the present invention, Lcs 2011 and Lcs 2021 have the same length. According to some embodiments of the present invention, Lcs2011 and Lcs2021 have different lengths. In other words, and according to some embodiment of the present invention, any length of transmitting antenna 2000, regardless of the number or order of quarter of the resonance frequency wavelength λ/4, can be used while WPT system 300 keeps the same resonance condition at predefined frequency. According to some embodiment of the present invention, by using transmitting antenna 2000, WPT system 300 maintain the same coupling coefficients and wireless power transfer efficiency, along and across direction P, regardless of the length of transmitting antenna 2000, when the same receiving antenna 110 is present in the predefined charging volume.

As opposed to the scenario described in FIGS. 4-5, where system 200 resonate only in antenna length L1 and L3 and not in L2. The novel WPT system 300, presents in FIGS. 8A and 8B, maintain the same coupling coefficients and wireless power transfer efficiency for a predefined resonance frequency for any variety of antenna lengths Lant along and across direction P, when the same receiving antenna 110 is present in the predefined charging volume. With continuance to previous examples, WPT system 300 now can resonate at antenna length L1, L2, and L3. FIG. 8B present some embodiment of the present invention, where novel WPT system's 300 transmitting antenna 2000 can be in any desired length, regardless to the number or order of the quarters of a wavelength (λ/4), by keeping the same coupling coefficients and wireless power transfer efficiency for a predefined resonance frequency for variety of actual transmitting antenna 2000 lengths along and across direction P.

As shown in FIG. 8B, signal conductor 201 and ground conductor 202 designed in a way that from one hand keeps the required conductor length Lcond required for the WPT system to resonates in predefined frequency and form the other hand the transmitting antenna length Lant=L2 is shorter, where in this example Lcond=L3. As shown in FIG. 8B, and according to some embodiment of the present invention, the length of the signal conductor 201 and ground conductor 202 Lcond is equal to the transmitting antenna length Lant and the electrical length of the conductor LC circuit Llcc. Meaning that, Lcond201=Lant+Llcc2111 and Lcond202=Lant+Llcc2121. According to the present example, where Lant=L2 and Lcond=L3, the electric length of conductor LC circuit Llcc=L3−L2. According to some embodiment of the present invention, Llcc2111 and Llcc2121 have the same electric length.

According to some embodiments of the present invention, Llcc2111 and Llcc2121 have different electric lengths. As shown in FIG. 8B the length of transmitting antenna 2000 Lant is L2, where signal conductor 201 LC circuit 2111 and ground conductor 202 connect to other LC circuit 2121. By changing the parameters of LC circuits 2111 and 2121 with regards to the length of the signal conductor 201 and ground conductor 202 respectively. For example, the electric length of signal conductor 201 Lcond and signal conductor 202 Lcond is equal to L3, where the actual transmitting antenna 2000 length is L2. In some embodiment of the present invention, each of the transmitting antenna conductors may have a different L length.

In some embodiment of the present invention, each conductor of the transmitting antenna 2000 may have different parameters set in each LC circuit. In some embodiment of the present invention, each LC circuit end can be opened, short, LC2111 connected to LC 2121 or a combination thereof.

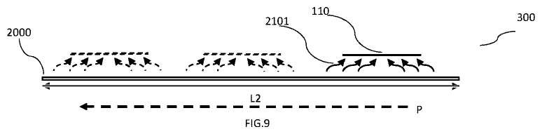

FIG. 9 presents some embodiment of the invention and illustrates a side view of novel WPT system 300, presented in FIG. 8A-8B, resonance conditions and power transfer at a predefined frequency for transmitting antenna with length Lant=L2. The resonance occurs only when receiving antenna 110 is present within the charging volume. As shown in FIG. 9 and according to one embodiment of the present invention, novel WPT system resonance conditions remain the same for the same receiving antenna 110 and with any length of transmitting antenna 2000 along and across direction P, regardless of the number or order of quarter of the resonance frequency wavelength.

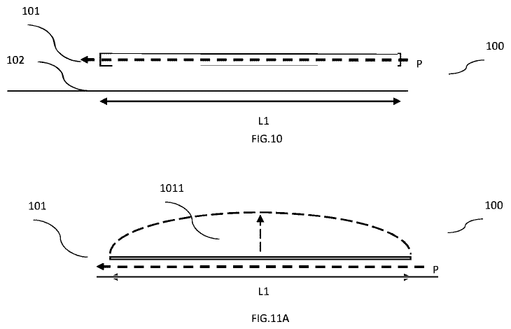

FIG. 10 illustrates a top view of the novel WPT system's transmitting antenna 100 signal conductor 101 and conductor ground 102, phase in the movement direction P over antenna and designated volume length L1.

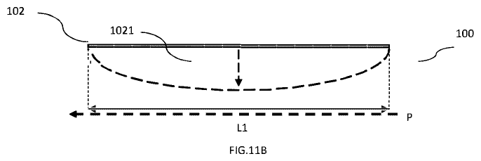

FIG. 11A-11B illustrates a side view of the transmitting antenna 100 signal conductor 101 and conductor ground 102 of the WPT system, phase, and field distribution in the movement direction P over antenna and designated volume length L1, where L1 is equal or smaller than the resonating frequency λ/4. As shown, according to at least one embodiment of the present innovation, the phase and field distribution 1011 over the signal conductor 101 is being kept along and across to the movement in P direction and over the transmitting antenna or the designated volume length L1, and opposite field distribution and phase 1012 is being kept over the transmitting antenna ground conductor 102 in along and across P direction and over the transmitting antenna or designated volume length.

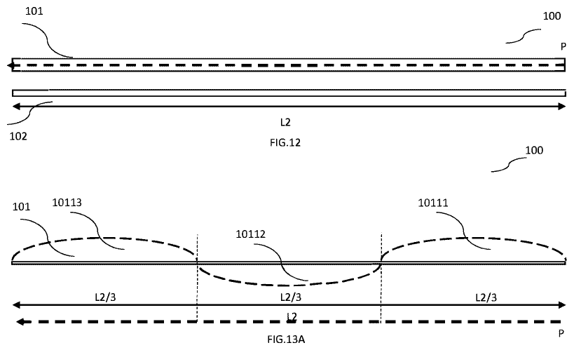

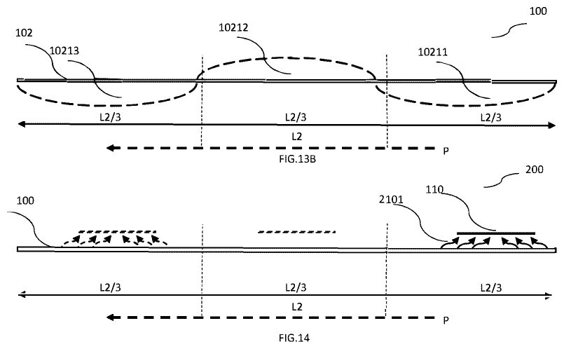

FIG. 12 illustrates a top view of the transmitting antenna 100 signal conductor 101 and conductor ground 102 of the WPT system, with a movement along direction P over antenna and designated volume length L2. Where L2 is equal to approximately 3λ/4. According to at least one embodiment of the present innovation and as shown in FIG. 12 and following FIG. 13A-13B, the phase and field distribution conditions are similar in direction P along and across the transmitting antenna and designated volume length L as follow: For n=1, 3 . . . and m=2, 4, . . . the phase and field condition over signal conductor 101 in section nλ/4 is the same as over ground conductor 102 section mλ/4. And for n=1, 3, . . . and m=2,4, . . . the phase and field condition over signal conductor 101 in section mλ/4 is the same as over ground conductor 102 section nλ/4.

FIG. 13A-13B illustrates a side view of the transmitting antenna 100 signal conductor 101 and conductor ground 102 of the WPT system, phase field distribution in the movement direction P over antenna and designated volume length L2, where L2 is equal to ¾ of the resonating frequency wavelength. As shown, according to at least some embodiment of the present innovation, the phase and field distribution over the signal conductor 101 is being change alone to the movement in P direction and over the transmitting antenna or the designated volume length L2, and opposite field distribution and phase is being change over the transmitting antenna ground conductor 102 in P direction and over the transmitting antenna or designated volume length.

As shown in FIG. 13A, and according to some embodiment of the present innovation the phase and field distribution over the signal conductor 101 is being change in according to the λ\4. As can be seen, in section L21 and L23, where L21 is the section of 0 to λ/4 m and L23 is the section of 2λ\4 to 3λ\4, the phase and field distribution 10111 and 10113 are similar over the signal conductor 101 and are being kept alone to the movement along and across in P direction and over the transmitting antenna or the designated volume length L2 in section L21 and L23.

An opposite field distribution and phase 10112 over the signal conductor 101 is also presented in FIG. 13A being kept along and across the movement in P direction and over the transmitting antenna or the designated volume length L2 in section L22, λ/4 m to 2λ/4 m.

In FIG. 13B, and according to some embodiment of the present innovation the phase and field distribution over the ground conductor 102 is opposite to phase and field distribution over the signal conductor 101 and is also being changed in according with the λ\4. As may be seen, in sections L21 and L23, where L21 is the section from 0 to λ/4 m and L23 is the section from 2λ\4 to 3λ\4m, the phase and field distribution 10211 and 10213 are similar over the signal conductor 101 and are being kept along and across the movement in P direction and over the transmitting antenna or the designated volume length L2 in section L21 and L23.

An opposite field distribution and phase 10212 over the signal conductor 102 is also presented in FIG. 13B, being kept along and across the movement in P direction and over the transmitting antenna or the designated volume length L2 in section L22, λ/4 m to 2λ/4 m. The result of such phase and field distribution changes along the movement in P direction and over the transmitting antenna or, the designated volume length L2 leads to inconsistent coupling condition along L2 and as a result, the wireless power transfer efficiency is changed accordingly. Meaning that coupling and resonance conditions represented by phase and field distribution 2101 are being changed along direction P within the designated charging volume, as shown in FIG. 14.

As presents in FIGS. 12-13 and according to some embodiments of the present invention, the movement in P direction, in order to maintain the same phase and coupling condition, requires a nonlinear movement in P direction, meaning that in every λ/4m, (of the resonance frequency wavelength), the receiving antenna, (not shown), needs to shift over signal conductor 101 and ground conductor 102.

In other words, the mobile platform (containing the receiving antenna—not shown), will have to move in repeatedly curved movement (slalom) in P direction in order to receive constant and continuance wireless energy from the transmitting antenna of the WPT system.

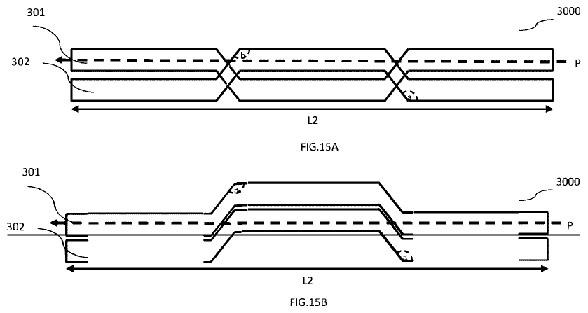

FIG. 15A-15B present some embodiments of the present invention and illustrates a top view of transmitting antenna 3000 signal conductor 301 and conductor ground 302 with a movement direction P over antenna and designated volume length L2. Where L2 is equal to ˜3λ/4. As shown and according to some embodiments of the present invention, transmitting antenna 3000 signal conductor 301 and conductor ground 302 are being physically shifted repeatedly every quarter of a wavelength, of the resonated frequency, along the movement in P direction and over the transmitting antenna or the designated volume length L2.

Angle a and b present the shifting angles of signal conductor 301 and ground conductor 302 of transmitting antenna 3000, where angle a present the turn shift angle and angle b present the return shift angle. In some embodiment of the present innovation, the turn shift angle and the return shift angle can be similar. In some embodiments of the present innovation the turn shift angle a and the return shift angle b of signal conductor 301 and ground conductor 302 can be similar.

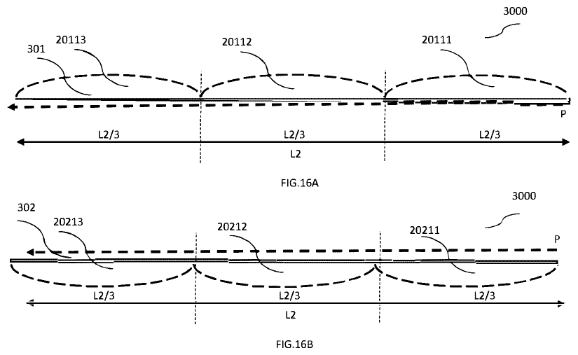

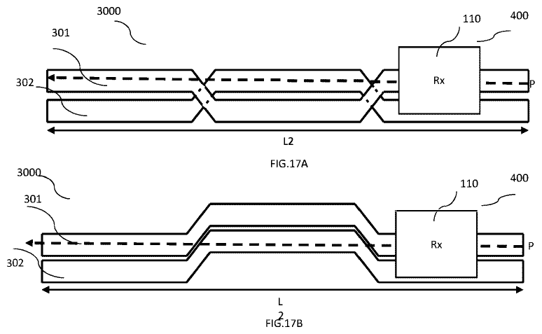

FIG. 16A-16B present some embodiments of the present invention and illustrates a side view of the transmitting antenna 3000 signal conductor 301 and conductor ground 302 phase field distribution in the movement direction P over antenna and designated volume length L2, where L2 is equal to 3λ/4m of the resonating frequency wavelength.

As shown in FIG. 15A-15B, according to at least one embodiment of the present innovation, the repeated physical shifting every quarter of a wavelength along transmitting antenna 3000 yields a condition where the phase and field distribution over the transmitting antenna 3000, is being kept along the movement in P direction and over the transmitting antenna or the designated volume length L2, as presented in FIG. 16A-16B.

As shown in FIG. 16A-16B, and according to some embodiment of the present innovation, the phase and field distribution over the transmitting antenna 300 in P direction is no longer being changed in according to the λ\4.

As may be seen, in sections L21, L22 and L23, the phase and field distribution 20111, 20112 and 20113 of signal conductor 301 and 20211,20212 and 20213 of ground conductor 302, are similar and kept along the movement in P direction and over the transmitting antenna 3000 or the designated volume length L2.

According to some embodiments of the present invention, the result of such phase and field distribution which are being kept along the movement in P direction and over the transmitting antenna 3000 or the designated volume length L2, leads to constant and continuance coupling condition along L2 and as a result, the wireless power transfer efficiency remain high and stable as presented in the following figures.

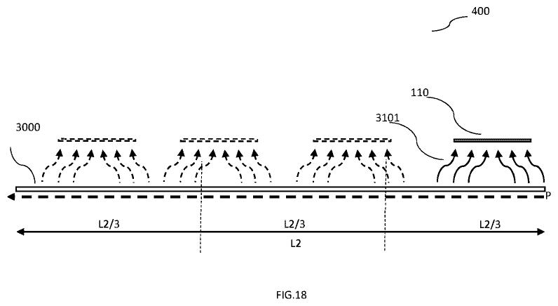

FIG. 17A-17B present some embodiments of the present invention and illustrates a top view of the WPT system 400. As shown, WPT 400 contains transmitting antenna 3000 and receiving antenna 110. Once receiving antenna 110 is present within the predefine charging volume, system 400 resonates in predefined frequency due to strong coupling conditions occurring between transmitting antenna 3000 and receiving antenna 110. As opposed to the conditions described in FIGS. 12-14, where the resonance and coupling condition change with regards to the location of receiving antenna 110 in direction P within the designated charging volume, the resonance and coupling condition of WPT system 400, shown in FIG. 17A-17B, are not changing and remain stable within the charging volume along direction P.

FIG. 18 presents at least one embodiment of the present innovation and illustrates a side view of the WPT system 400. Receiving antenna 110 is located within the designated charging volume. As a result, WPT system 400 start to resonate in predefined frequency due to strong coupling conditions occurring between transmitting antenna 3000 and receiving antenna 110. As shown in FIG. 18, and according to some embodiment of the present innovation, WPT system 400 coupling and resonance conditions represented by phase and field distribution 3101 are not being changed in the along and across direction P within the designated charging volume. Meaning that the same amount of wireless energy is being constantly, continually, and efficiently delivered from transmitting antenna 3000 to receiving antenna 110.

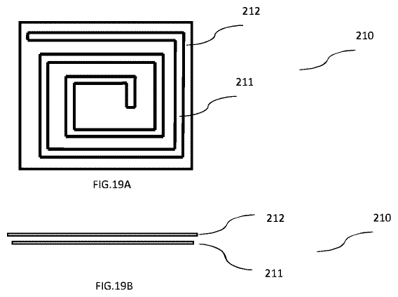

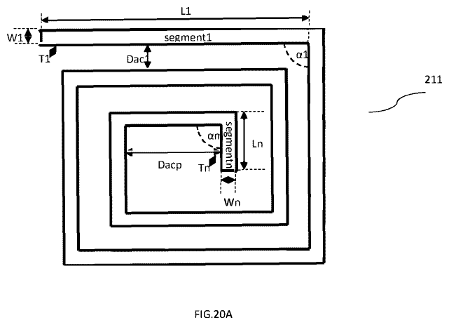

FIG. 19-21 presents an example of receiving antenna for the novel WPT system. According to some embodiment of the invention, the receiving antenna of WPT system can have any shape, structure and dimensions creating resonance condition at predefined frequency with the WPT system transmitting antenna, while presented within the designated and predefined charging volume.

FIG. 19A-19B illustrate a bottom and side view of the novel WPT system's receiving antenna 210 having a signal conductor 211 and a ground conductor 212. FIG. 19A present the bottom view and FIG. 19B presents the side view.

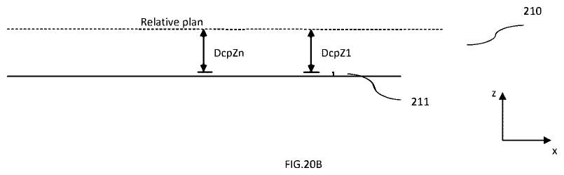

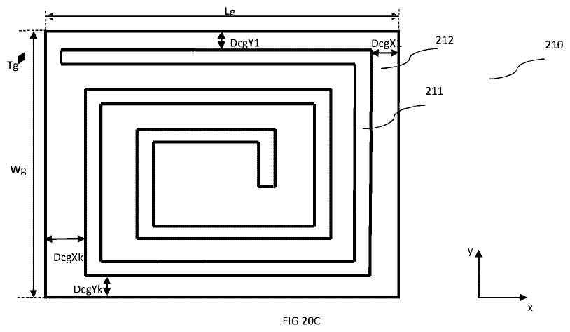

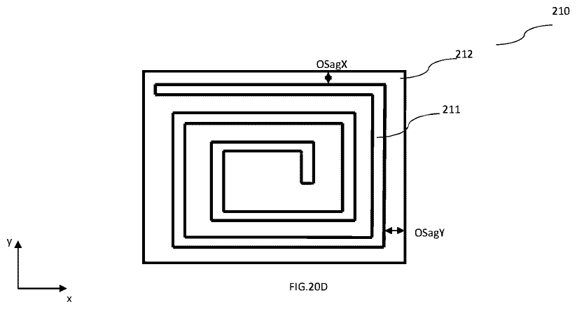

FIG. 20A-20E illustrate a side and bottom view of at least one embodiment of receiving antenna 210 parameters. According to one embodiment of the invention, WPT system only resonates at the predefined frequency when the receiving antenna 210 is present within the predefined charging volume. In order to achieve such resonance condition, receiving antenna 210 and transmitting antenna need to have mutual electromagnetic influence which leads to such resonance.

According to one embodiment of the invention, the novel WPT system receiving antenna 210 and transmitting antenna maintain a similar resonance condition if the receiving antenna 210 is present within the charging volume and without any limitation or requirement of position, orientation, rotation, alignment, overlapping, placement, etc. with regards to the transmitting antenna. In other words, according to some embodiments of the invention, the novel WPT system maintains a spatial resonance condition, at the predefined frequency, between the transmitting antenna and the receiving antenna regardless of placement, location, orientation, rotation, overlapping, alignment, etc. while the receiving antenna 210 is locate within the predefined charging volume.

According to one embodiment of the invention, the resonance condition of novel WPT system reflects a high coupling coefficient and efficient wireless power transfer between the transmitting antenna and the receiving antenna 210 regardless of placement, location, orientation, rotation, overlapping, alignment, etc. while receiving antenna 210 is locate within the predefined charging volume.

FIG. 20A-20B present the dimensions and the parameters set for receiving antenna 210 and signal conductor 211. The parameters include the length, width, and thickness of each conductor segment (Ln, Wn, Tn) and the relative angle (αm), heights (DcpZn) and distance (Dacp) of adjacent conductor segments.

According to one embodiment of the invention, WPT system resonance condition for a predefine frequency can be changed, adjust, set, etc. by changing the conductor segment parameters, such as length, width, and thickness of each conductor segment (Ln, Wn, Tn) and the relative angle (αm), height distance (DcpZn) and distance (Dacp) of adjacent conductor segments of signal conductor 211.

FIG. 20C-20F present the dimensions and the parameters set for the receiving antenna 210 ground conductor 212 and the relative placement of antenna conductor 211 to ground conductor 212. The parameters include the length, width and thickness (Lg, Wg, Tg) of ground conductor 212 and the relative angle (β), heights (DagZ) and planar distance (DagX and DagY) to signal conductor 211.

According to one embodiment of the invention, WPT system resonance condition for a predefine frequency can be changed, adjust, set, etc. by changing length, width, and thickness (Lg, Wg, Tg) parameters of receiving antenna 210 and ground conductor 212. According to one embodiment of the invention, WPT system resonance condition for a predefine frequency can be changed, adjust, set, etc. by changing the relative angle (β), heights (DagZ) and planar distance (DagX and DagY) of receiving antenna 210 and ground conductor 212 to signal conductor 211.

According to one embodiment of the invention, WPT system resonance condition for a predefine frequency can be changed, adjust, set, etc. by changing length, width and thickness (Lg, Wg, Tg) parameters and relative angle (β), heights (DagZ) and planar distance (DagX and DagY) of the receiving antenna 210 and ground conductor 212 to signal conductor 211.

According to one embodiment of the invention, WPT system resonance condition for a predefine frequency can be changed, adjust, set, etc. by changing the conductor segment parameters, such as length, width and thickness of each conductor segment (Ln, Wn, Tn) and the relative angle (αm), height distance (DcpZn) and distance (Dacp) of adjacent conductor segments of signal conductor 211, and by changing the receiving antenna 210 ground conductor 212 length, width and thickness (Lg, Wg, Tg) parameters, and by changing the relative angle (β), heights (DagZ) and planar distance (DagX and DagY) between signal conductor 211 and ground conductor 212 of receiving antenna 210.

According to some embodiments of the invention, the input RF power port which transfers the receiving power from receiving antenna 210 to the receiving unit and rectifier (not shown) may be connected to any place on any conductor segment of signal conductor 211 and ground conductor 212 of receiving antenna 210.

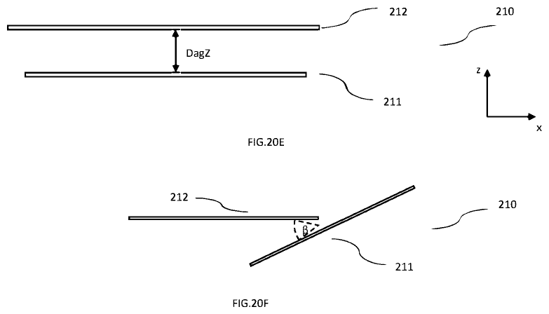

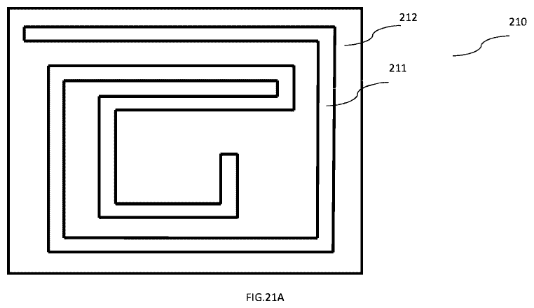

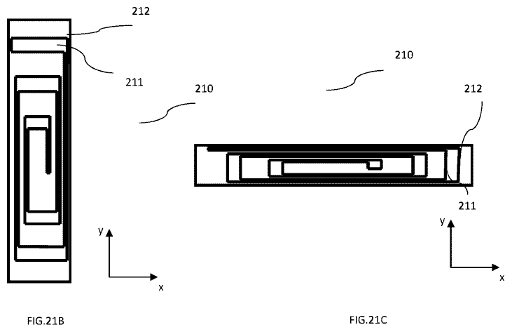

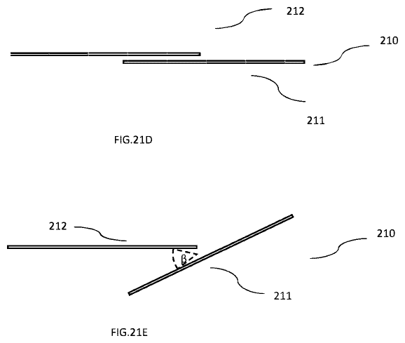

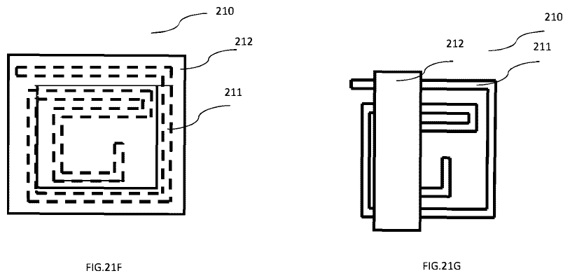

Reference is now made to FIG. 21A-21G illustrating a few variations of receiving antenna 210 of novel WPT system. According to some embodiment of the present invention, the conductor segments of signal conductor 211 can have any shape, structure and dimensions which create resonance condition at predefined frequency with the transmitting antenna, while presenting within the designated and predefined charging volume.

As shown in FIG. 21A, the structure of the conductor segment can be set in any continuance order to create any form of structure of signal conductor 211.

FIG. 21B-21C present some embodiments of a two narrow structure of receiving antenna 210, where FIG. 21B is narrow in X direction and FIG. 21C is narrow in Y direction.

FIG. 21D-21E illustrate yet another embodiment, where the relative position between signal conductor 211 and ground conductor 212 of receiving antenna 210 can be changed, adjust, set, etc. to create resonance condition at predefined frequency with the transmitting antenna, while presenting within the designated and predefined charging volume of the WPT system.

FIG. 21F-21G illustrates yet another embodiment of the invention, where the structure of receiving antenna 210 and ground conductor 212 can be in any shape, dimension, structure, and form which creates resonance condition at predefined frequency with the transmitting antenna, while presenting within the designated and predefined charging volume. As shown in FIG. 21F, ground conductor 212 may have a frame shape where ground conductor 212 does not fully cover signal conductor 211 of receiving antenna 210. FIG. 21G shows yet another embodiment of the present invention where the ground conductor 212 of receiving antenna 210 is much smaller than the area covered by signal conductor 211 and does not fully cover signal conductor 211 of receiving antenna 210. In some embodiments of the present invention, ground conductor 212 of receiving antenna 210 may not fully cover, have larger dimensions, be aligned, overlap, be parallel to signal conductor 211 of receiving antenna 210 which creates resonance condition at predefined frequency with the transmitting antenna, while presenting within the designated and predefined charging volume.

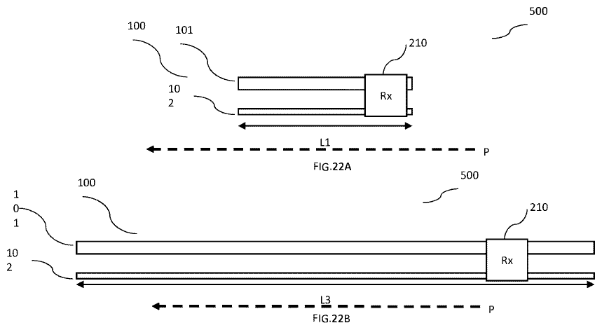

FIG. 22A-22B illustrate a top view of the novel WPT system 500, transmitting antenna 100, signal conductor 101, conductor ground 102, and receiving antenna 210. FIG. 22A presents transmitting antenna 100 with length of L1 and FIG. 22B presents transmitting antenna 100 with of L2. The receiving antenna 210 of WPT system 500 in FIGS. 22A and 22B is the same.

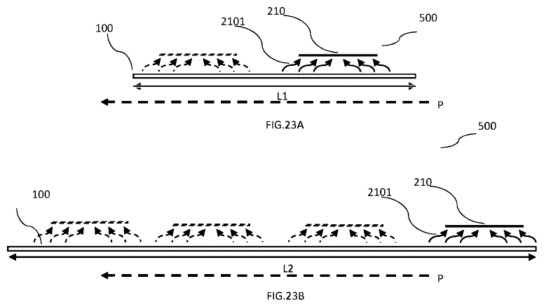

FIG. 23A-23B illustrates a side view of WPT system 500 resonates and power transfer at a predefined frequency. The resonance occurs only when receiving antenna 210 is present within the charging volume. As a result, and according to some embodiments of the present invention, a high coupling and highly efficient power transfer occurs between the transmitting antenna 100 and receiving antenna 210, along and across direction P within the charging volume of WPT system 500.

In one embodiment of this invention, System 500 presents in FIG. 23A-23B resonates at the same frequency and held the same coupling coefficients and wireless power transfer efficiency for both transmitting antenna length of L1 and L3 with the same receiving antenna 210 along and across direction P within the charging volume.

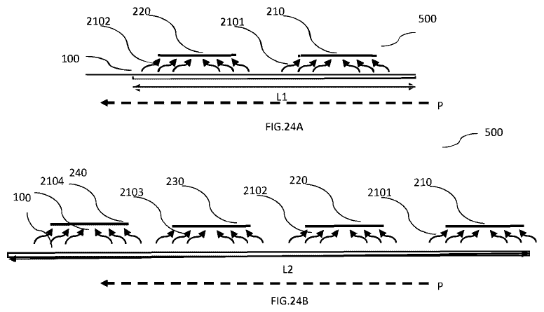

FIG. 24A-24B illustrate a side view of at least one embodiment of WPT system 500, presenting simultaneous coupling and wireless power transfer with variety lengths of transmitting antenna 100 and receiving antennas 210 to 240. According to one embodiment of the present innovation, resonance occurs only when at least one receiving antenna 210 is present within the charging volume. As can be seen in FIG. 24A, WPT system 500 resonates when receiving antennas 210 and 220 are present within the changing volume resulting a strong simultaneous coupling and efficient wireless power transfer between transmitting antenna 100 and receiving antennas 210 and 220 along and across direction P within the charging volume.

According to some embodiments of the present innovation, the creation of such simultaneous coupling between transmitting antenna 100 to at least two receiving antennas 210 and 220 is functioning as a wireless power divider, is where the power transferred from the transmitting antenna is equally divided by at least two receiving antennas presented within the charging volume. FIG. 24B presents the equal wireless power divider of system 500, wherein four receiving antennas are present within the charging volume, and the power is efficiently wirelessly transferred form transmitting antenna 100 and divided equally between receiving antennas 210, 220, 230 and 240.

According to some embodiments of the present innovation, the simultaneous coupling and wireless power transfer between the transmitting antenna and the at least two receiving antenna is maintained while the at least two receiving antennas, located within the charging volume, regardless if the at least two receiving antennas are stationary, in motion, at least one stationary and at least one in motion, differs in location, differs in orientation, differs in rotation and positioning within the charging volume.

According to some embodiments, the novel spatial WPT system's receiving antenna may be formed in various shapes and sizes or may include various inner/outer conductors. In accordance with some embodiments of the invention, the novel spatial WPT system's transmitting antenna is composed of a conductive wire or strip alongside or between one or more ground conductive wires or strips.

A predefined transmitting antenna dimension parameters such as, length, width, thickness or radius of the signal conductor and the ground conductor, the distance between the signal conductor and the ground conductor/s, the relative height between the signal conductor and the ground conductor and so, affect the covered charging and powering area, the covered charging and powering volume, the field distribution and so on, for a given frequency, and vice versa.

In one embodiment, a transmitting antenna of the WPT system conductor cross section is a round, rectangular, or any other geometrical shape, or combinations thereof.

In one embodiment, the WPT system maintains high coupling and energy transfer efficiency within, across and along, the relatively large area and volume covered. In one embodiment, the transmitting antenna is configured to be attached to a receiving unit of a wireless charging system, or a transmitting unit of a wireless charging system.

In one embodiment, a transmitting antenna is configured to be attached to a transmitting unit and a transmitting antenna with a different dimension parameter is configured to be attached to receiving unit of a WPT system, and vice versa.

In some embodiments of the present invention, WPT system, with the same receiving antenna, will resonate at the same frequency and held the same coupling coefficients and wireless power transfer efficiency for any transmitting antenna, conductors with the length of Nλ/4m, where λ is the wavelength of the predefined resonance frequency and N=1,3 . . . as the number of quarters of wavelengths.

In some embodiments of the present invention, WPT system, with the same receiving antenna, resonates at the same frequency and held the same coupling coefficients and wireless power transfer efficiency for any transmitting antenna with the length of Nλ/4m, where λ is the wavelength of the predefine resonance frequency and N=2,4 . . . as the number of quarters of wavelengths.

In some embodiments of the present invention, WPT system resonates at the same frequency and holds the same coupling coefficients and wireless power transfer efficiency for any transmitting antenna length regardless of the predefined resonance frequency quarter of a wavelength number or order.

In one embodiment, the resonance frequency of WPT system is determined by both transmitting and receiving antennas.

In one embodiment, the resonance frequency of WPT system is determined by both transmitting and receiving antennas and may be modified by changing the parameters of the transmitting antenna, receiving antenna, or both.

In one embodiment, the presence or absence of the receiving antenna affects the return loss of the transmitting antenna of the WPT system in the desired resonance frequency.

In one embodiment, the presence or absence of the transmitting antenna affects the return loss of the receiving antenna of the WPT system in the desired resonance frequency.

In one embodiment, the charging and powering area and volume of WPT system is determined by both transmitting and receiving antennas.

In one embodiment, the charging and powering area and volume of WPT system is determined by both transmitting and receiving antennas and may be modified by changing the parameters of the transmitting antenna, receiving antenna, or both.

In one embodiment, the WPT system, contains the transmitting antenna and receiving antenna, maintaining high coupling and energy transfer efficiency within, along and across, the relatively large area and volume covered.

In one embodiment, the WPT system, contains the transmitting antenna and receiving antenna, maintaining high coupling and energy transfer efficiency within the relatively large area and volume covered when the transmitting antenna or the designated charging volume length is greater than quarter of the resonance frequency wavelength λ/4m.

In one embodiment, the WPT system, contains the transmitting antenna and receiving antenna, maintaining high coupling and energy transfer efficiency within the relatively large area and volume covered regardless of position, location, rotation, orientation, overlapping, alignment etc. of the receiving antenna relatively to the transmitting antenna.

In one embodiment, the transmitting antenna may be coupled to one or more receiving antennas of the WPT system, meaning multi mobile platform wirelessly powering.

In one embodiment, at least one transmitting antenna may be attached to a transmitting unit.

In one embodiment, a plurality of transmitters and transmitting antennas may be used to increase the coverage of the desired charging and powering area, volume, field distribution and so on.

In one embodiment, the WPT system may eliminate the need of a stationary charging system for in-motion mobile platform charging and powering while moving.

In one embodiment, the receiving antenna of the WPT system is connected to receiving unit. The receiving unit is attached/assembled/integrated on/in/within the mobile platform. The receiving unit rectifies the wirelessly received electromagnetic or electric power and converts it to DC power. The DC power is charging or powering the mobile platform, while the mobile platform is located within the charging volume.

In one embodiment, the WPT system may eliminate the need or reduce the size of the in-motion mobile platform battery.

In one embodiment, the transmitting antenna of the WPT system, may be assembled on, within or beneath asphalt roads, paths, sidewalks, storage, aisles, interior and exterior floors and so on.

In one embodiment, the WPT system may be used as stationary wireless charging system for at least one receiving antenna connected to receiving unit with no or less alignment, overlapping and proximity constrain.

In one embodiment, the transmitting antenna of the WPT system may be assembled vertically on walls, storage shelves, interior structure, exterior structure and so on.

In one embodiment, the novel WPT system may be implemented to charge and power one or more in-motion mobile platforms. Some none limiting examples are locomotor device, electric vehicles, hybrid vehicles, robots, smart warehouse robots, agriculture robots, smart warehouse transportation, buses, public transportation, aerial vehicle, electric scooters, and any type of locomotor/vehicle, either autonomous or controllable, configured to be operatable above, within or under the ground, above or under water, in air, space, etc.

1. A near field spatial Wireless Power Transfer (WPT) system based on conductors' system configured to cover large area and volume while maintaining high electromagnetic (EM) coupling and efficient wireless power transfer between the transmitters and the receivers as part of wireless powering and charging system, comprising:
at least one alternating power signal source;
at least one transmitting antenna comprising:
at least one signal conductor configured to receive an electrical signal from said power signal source and further configured to be stretched along a path;
at least one ground conductor configured to be in communication with a ground of said power signal source and further configured to be stretched along said path;
at least one receiving antenna;
at least one receiving unit;
wherein a resonance within a charging volume, occurs between the transmitting antenna's signal conductor and ground conductor, both connected to the alternating power signal source, and the receiving antenna, enables constant and continuous EM coupling between the at least one transmitting antenna and to at least one receiving antenna; and
wherein the signal conductor is configured to be disposed in a predefined
distance from the ground conductor whereby the charging volume is formed, regardless of the number or order of the predefined resonance frequency quarters of wavelength;
wherein a constant and continuously wireless charging/powering is provided for receiving antenna connected to receiving unit while in motion or stationery positioned within predefine charging area.

2. (canceled)

3. The system of claim 1 wherein the at least one alternating power signal source is in communication with the receiving antenna whereby the function of the other conductors is modified accordingly.

4. The system of claim 1 wherein the predefined distance between the signal conductor and ground conductor along the path, determines the dimensions of the charging volume.

5. (canceled)

6. The system of claim 1 wherein the at least one signal conductor is configured to be placed between at least two ground conductors, and wherein said conductors are configured to be spaced by a predefined distance along the path.

7. The system of claim 1 wherein the at least one signal conductor and the at least one ground conductor are configured to be mounted on or beneath ground level.

8. (canceled)

9. The system of claim 1 wherein the at least one signal conductor and the at least one ground conductor are configured to be mounted on a vertical surface or a moving object.

10. The system of claim 1 wherein the at least one signal conductor and the at least one ground conductor are configured to be made of a conductive material having a thickness of 50-150 micron.

11. (canceled)

12. (canceled)

13. The system of claim 1 wherein the receiving antenna is configured to maintain constant and continuous EM coupling with the at least one signal conductor and the at least one ground conductor if it remains within a charging volume.

14. (canceled)

15. (canceled)

16. (canceled)

17. (canceled)

18. The system of claim 1 wherein the transmitting antenna conductors are at least partially meandering.

19. The system of claim 1 wherein at least one of the signal conductor, and the ground conductor are configured to have different dimensions along their length to provide adaptive resonance and EM coupling capabilities.

20.-21. (canceled)

22. The system of claim 1 wherein the receiving antenna and transmitting antenna have mutual electromagnetic influence so that the system resonates at the predefined resonance frequency, when the receiving antenna is present within the predefined charging volume.

23.-28. (canceled)

29. The system of claim 1 wherein the resonance condition for a predefine frequency is adjustable, by changing one or more of the receiving antenna conductor segment parameters, selected from a list consisting of: length, width, and thickness of each conductor segment and the relative angle (αm), height distance (DcpZn) and distance (Dacp) of adjacent conductor segments of signal conductor.

30. The system of claim 1 wherein the resonance condition for a predefined frequency is adjustable, by changing one or more of the receiving antenna ground conductor parameters selected from a list consisting of: length, width, thickness, size and shape.

31. The system of claim 1 wherein the resonance condition for a predefined frequency is adjustable, by changing one or more of: the receiving antenna signal conductor position, angle, alignment, overlapping, tilting, rotation area size ratio, with regards to the receiving antenna ground conductor.

32. The system of claim 1 further comprising an input RF power port for transferring the receiving power from receiving antenna to the receiving unit and a rectifier connected to a conductor segment of one of the signal conductor and ground conductor of receiving antenna.

33. The system of claim 1 wherein the simultaneous coupling and wireless power transfer between the transmitting antenna and at least two receiving antennas is maintained while at least two receiving antennas, located within the charging volume, regardless if the at least two receiving antennas are stationary, in motion, at least one stationary and at least one in motion, differs in location, differs in orientation, differs in rotation and positioning within the charging volume.

34.-35. (canceled)

36. The system of claim 1 wherein the charging area for a given frequency is defined by at least one of: transmitting antenna length, transmitting antenna width, transmitting antenna thickness, ground conductor radius, ground conductor radius, the distance between the signal conductor and the ground conductor, the relative height between the signal conductor and the ground conductor.

37. A method for using a near field power system, comprising the steps of:
providing an alternating power signal produced by at least one transmitter;
communicating said alternating power signal to at least one signal conductor while the at least one ground conductor is in communication with the transmitter ground;
wherein both conductors are configured to be stretched along a path and
disposed in predefined distance from each other;
providing at least one receiving antenna configured to be mounted on at least one mobile platform;
forming an electromagnetic (EM) resonance between the at least one signal conductor together with at least one ground conductor and the receiving antenna, creating a constant and continuous EM coupling between the signal together with the ground conductors and the receiving antenna.
